(19) United States
(12) Patent Application Publication
(10) Pub. No.: US 2012/0102967 A1
(43) Pub. Date: May 3, 2012

(54) Method and system for preventing combustion instabilities during transient operations

(75) Inventors: Joseph Kirzhner, Greenville, SC (US); Predrag Popovic, Greenville, SC (US)

(73) Assignee: General Electric Company, Schenectady, NY (US)

(21) Appl. No.: 12/926,121

(22) Filed: Oct. 27, 2010

(51) Int. Cl. F02C 9/00

(52) U.S. Cl. 60/773; 60/39.24

(57) ABSTRACT

A method and system for preventing or reducing the risk of combustion instabilities in a gas turbine includes utilizing a turbine controller computer processor to compare predetermined and stored stable combustion characteristics, including rate of change of the characteristics, with actual operating combustion characteristics. If the actual operating combustion characteristics are divergent from stable combustion characteristics then the controller modifies one or more gas turbine operating parameters which most rapidly stabilize the operation of the gas turbine.

### FIELD OF TECHNOLOGY

The exemplary implementations are directed to methods and systems for preventing combustion instabilities during transient operations of gas turbines. More particularly, combustion characteristics and dynamics are changed to eliminate or reduce the risk of combustion instabilities, especially the risk of un-desired flame holding events, or re-ignitions, such as Flashback/Primary Re-Ignition (PRI) at the primary fuel nozzle of the Dry Low NOₓ (DLN) combustor, during the combustion process in gas turbines.

### BACKGROUND

Depending on the type of fuel mixture utilized in a gas turbine, the risk of Flashback/PRI can be increased. Since it is cost effective to use a mixture of high and low quality fuels it has been proposed to monitor the state of combustion in a gas turbine and after Flashback/PRI is detected then actions are taken to adjust the relative amounts of the fuels in the fuel mixture and/or the flow of air to thereby halt Flashback/PRI.

More particularly, flame detectors are positioned upstream from the discharge ends of fuel and air premixing passages which detect the light emitted after the occurrence of Flashback/PRI. After detecting the occurrence of Flashback/PRI the fuel flow control valves are adjusted to eliminate the Flashback/PRI. Thus, this methodology is reactive in that it is implemented only when the combustion instability, i.e., Flashback/PRI, has already been detected at which time gas turbine operating efficiency and/or gas turbine equipment may have already suffered damage or been degraded by Flashback/PRI.

Other combustion instabilities, which need to be predicted and avoided, include undesired amplitude, of combustion CO emissions, elevated combustion pressure amplitude and fluctuations (Cold Tone) at the low combustor operating temperature, and turbine load, especially when burning low LHV gas fuel blends. Another type of combustion instabilities relate to high NOₓ emissions, elevated combustion pressure amplitude and fluctuations (Hot Tone) at the high combustor operating temperature, and turbine load, especially when burning high LHV gas fuel blends.

### SUMMARY

In order to operate gas turbines cost effectively it is necessary for different types of fuels, or mixtures of fuels having varying thermal and chemical compositions to be utilized. Operating efficiencies will result from extending the Fuel Flex space to include a mixture of high and low cost fuels, e.g., high LHV fuels and low LHV fuels.

High LHV fuels, such as fuel blends with high concentration of High Hydrocarbons (HHC), Hydrogen (H2) in Natural Gas (NG) application, could improve flame stability, and extend turbine operability at part load operating conditions, but increase the risk of Flashback/PRI, high dynamics (pressure oscillations), combustor NOₓ emissions, resulting in heavy damages. High reactivity blends with increased high LHV fuels concentration create problems related to un-desirable flame oscillations, especially during the transient (increased speed and power output, changing fuel composition, etc.) operating conditions.

The consequences of Flashback/PRI for field turbines can be devastating so there is a need to detect when such combustion instabilities are likely to occur so that proactive measures can be taken to prevent their occurrence. For example, the occurrence of combustion instabilities such as Flashback/PRI can be prevented by controlling the time rate of the change of the combustion oscillations (amplitude of vibration), and its absolute value. More particularly, monitoring the time rate of change in combustion oscillations can effectively predict whether Flashback/PRI will occur so that proactive measures can be taken, i.e., measures that adjust the time rate of change in combustion oscillations, to thereby prevent or at least reduce the risk of its occurrence. Other combustion instabilities that can be prevented from occurring include Hot Tone, NOₓ emissions for high LHV fuels, Cold Tone, Lean Blow Off (LBO), and high CO which all result from the use of low LHV fuels, especially at cold ambient temperatures and part load operating conditions.

The exemplary implementations of the new methodologies described herein involve measuring absolute dynamic oscillations values, calculating timing rate of oscillations amplitude change, comparing to what is prescribed for these measured and calculated parameters, and changing these parameters by one or more ways which provide the fastest response. The preventative ways to change combustion characteristics and dynamics to prevent Flashback/PRI and other combustion instabilities include changing or modifying one or more gas turbine operating parameters including: Fuel-to-Air Ratio (FAR); Fuel and air distribution within the combustor (e.g., change fuel Primary, Secondary, Pilot, Late Lean Injection by modifying fuel splits; change air flow splits between combustion zones); absolute value and rate of fuel and air supply change; rate of fuel composition; adding inert gases and/or water/steam to the combustor; the flow rate and/or make up of emissions gases such as COₓ, NOₓ, unburned Hydrocarbons, etc.

All of the enumerated ways of changing the combustion dynamics are controlled by the turbine controller. The combustion controller adjusts the dynamics growth rate, based on turbine operating conditions, correlated to the pre-defined and/or to “right now calculated” rate of allowable change of oscillations amplitude. As noted previously, a reduced rate of oscillations growth will reduce the risk or prevent Flashback/PRI and other combustion instabilities.

### BRIEF DESCRIPTION OF DRAWINGS

FIG. 1 is a graph which illustrates the rate of change in combustion oscillation that indicates an increased risk of Flashback/PRI;

FIG. 2 shows in schematic form an exemplary implementation of a system controller and sensors utilized for preventing Flashback/PRI; and

FIG. 3 is a flowchart showing an exemplary implementation of the method for preventing Flashback/PRI.

### DETAILED DESCRIPTION

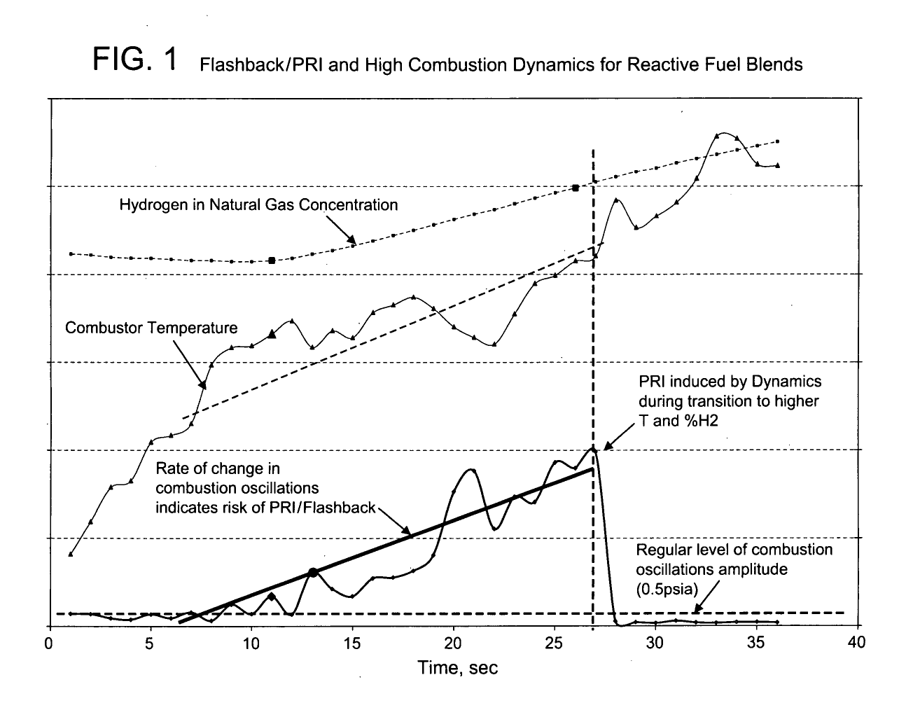

FIG. 1 shows the rate of change in amplitude of combustion oscillations (i.e., rapid amplitude changes in pressure or noise) during an exemplary test where the primary fuel split is 75 to 85%, pilot 0.2 to 1.4% of total fuel rate, TCD (temperature at combustion discharge) is 600 to 800° F., PCD (pressure at compressor discharge) is 160 to 200 psi, and combustor inlet air flow of 45 to 80 pps. The oscillating heavy line shows the rate of change in amplitude of combustion oscillations which increases over time as combustor operating temperature and H₂ concentration increases. The straight solid line approximates the slope of the curve thereby depicting the rate of change in amplitude of combustion oscillations. The other curves show H₂ concentration and combustion temperature. Although an exemplary implementation monitors the time rate of change of H₂ concentration, the time rate of change of other gases could be monitored including, but not limited to, propane, methane, butane, and ethane.

Flashback/PRI is shown to occur just prior or at the point on the graph when the heavy combustion oscillating line goes to zero. The graph further shows that Flashback/PRI is induced during transition to the higher combustion temperature of 2100 to 2400° F. and an Hydrogen (H₂) concentration of 20 to 90%. Acquired test data indicates that increased rate of change in the combustion dynamics amplitude, and/or the fuel reactivity (expressed by H2 concentration in FIG. 1) rate of change, or the Combustor operating temperature (FIG. 1), rate of change, or emissions rate of change (not shown in FIG. 1), could be used as indicators to forecast possibilities of PRI. These indicators could be used separately, and or together, for example, dynamics amplitude rate of change depends, and should be limited, based on the immediate Combustor operating temperature, or Hydrogen concentration ranges of change.

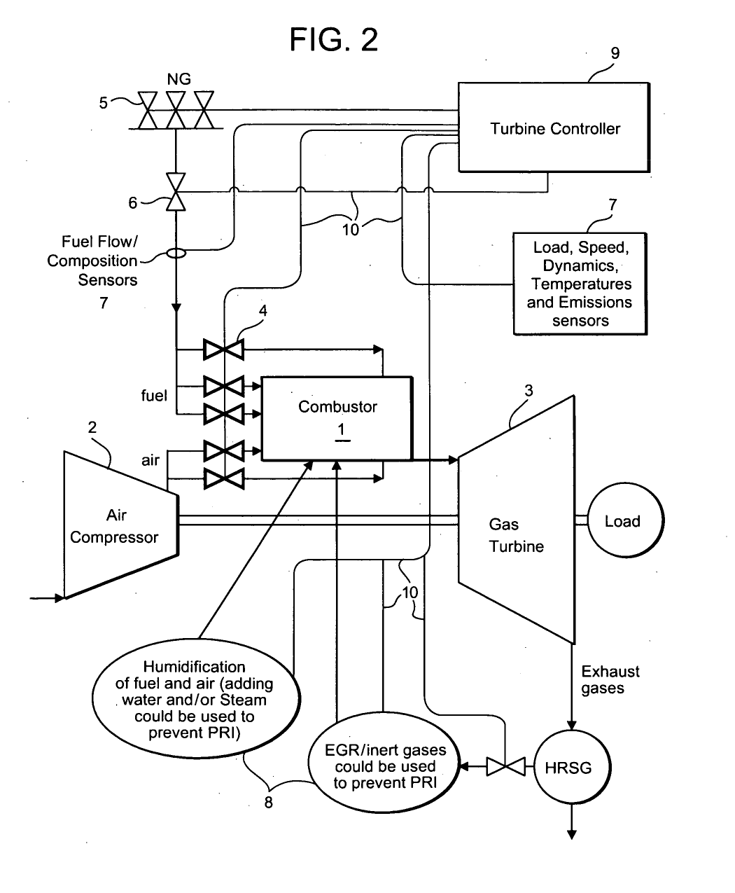

FIG. 2 shows an exemplary implementation of a gas turbine system for preventing combustion instabilities during transient gas turbine operations. The system includes combustor 1, air compressor 2, turbine 3, fuel and air delivery valves 4, fuel mixture valves 5, fuel flow valve 6, sensors and/or flow meters 7, injection devices 8 for water and/or steam and inert gasses, turbine controller 9, and connecting lines 10 between turbine controller 9 and the various controlled devices, i.e., valves 4, 5, 6, sensors and flow meters 7 and injection devices 8. The injection devices include suitable valves (not shown) for injecting water and/or steam into the combustion chamber, re-circulating exhaust gases (EGR), and/or injecting inert gases into the combustion chamber to prevent Flashback/PRI.

Fuel and air delivery valves 4 are provided for obtaining desired changes in combustion parameters by changing the fuel to air ratio supplied to the gas turbine system, and fuel and air distribution within combustor 1. For example, to avoid PRI, and or high NOₓ, for increased reactivity fuel blends, more fuel could be directed and injected to the right end/exit of combustor 1 (this method is often referred to as Late Lean Injection). Fuel mixture valves 5 are provided to change the fuel composition supplied to the gas turbine system by adding various reactivity fuels. Fuel flow valve 6 is provided for adjusting the total fuel flow and fuel flow time rate.

Fuel composition sensors and/or flow meters 7 located immediately downstream of fuel mixture valves 5 serve to estimate fuel composition. Valves 4, 5, 6, sensors and flow meters 7 and injection devices 8 are operatively connected to turbine controller 9 which generates operating commands based on the comparison of stored predefined values for the valves and sensors or flow meters.

More particularly, when combustion oscillations exceed allowed value, turbine controller 9 chooses the control means having the fastest response for reducing the absolute amplitude and time rate of combustion oscillations thereby avoiding Flashback/PRI, for example, changing the time rate of adding H₂ to the fuel blend (or other gases such as those identified previously), air-to-fuel ratio, and/or fuel distribution (varying load of the combustion zones) within the combustor. Specifically, to prevent or reduce the risk of combustion instabilities the rate of combustion oscillations is reduced by turbine controller 9 through generating operating commands to drive combustor 1 and turbine 3 to predetermined stable operating conditions by changing fuel composition, fuel blend reactivity, fuel to air ratio, fuel and/or air distribution within the combustor, and/or by adding fuel, etc. As noted above, fuel reactivity can be reduced by adding less reactive gases than methane (e.g., CO) or inert gases (N, CO₂).

Although the above described exemplary implementation monitors the time rate of change of combustion oscillations and takes corrective action when the rate is outside normal stable transient operating conditions, other parameters can be monitored or calculated for triggering corrective action. For example, fuel reactivity factor, estimated by such values, as ignition delay and or blow off time, or fuel flammability limits, or fuel adiabatic temperature, or fuel-air stoichiometric ratio can be monitored and compared to values previously stored for normal stable transient operations.

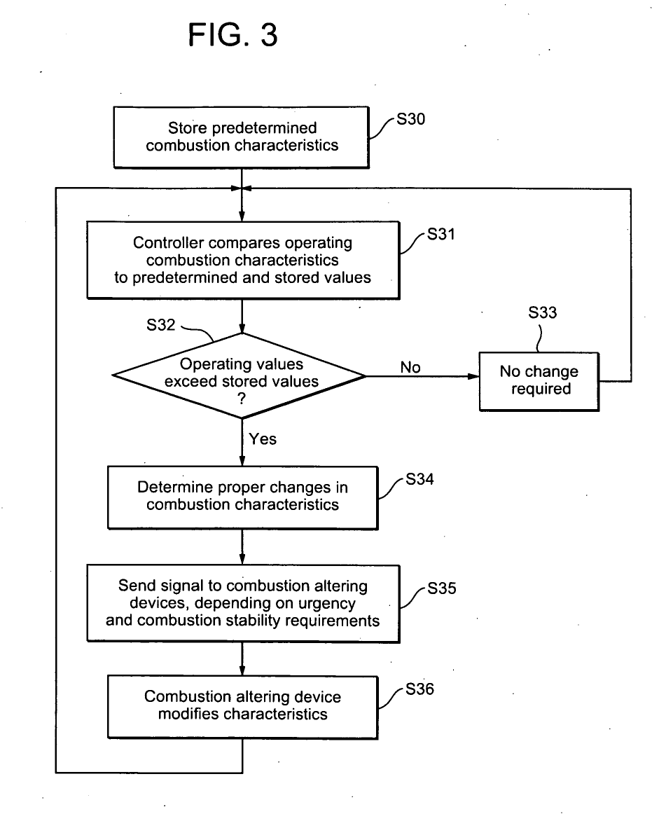

FIG. 3 shows an exemplary method for preventing combustion instabilities or Flashback/PRI during gas turbine transient operations. In first step S30 gas turbine combustion characteristics are predetermined and stored, e.g., absolute amplitude and rate of change in dynamics amplitude, combustor operating temperature, exhaust gases profile used to predict and prevent Flashback/PRI. In step S31, turbine controller 8 compares operating combustion characteristics to those previously stored, e.g., comparing rate of change in dynamics amplitude to the predetermined values.

In step S32 it is determined if the operating combustion characteristics exceed the predetermined and stored values in step S30. If the answer is NO, then no changes are required and flow chart returns to step S31. If the answer is YES, then the flow chart proceeds to step S34 wherein proper changes in combustion characteristics are determined. Step S34 involves determining the action or actions that should be taken to most rapidly adjust the combustion characteristics to prevent or reduce the risk of combustion instabilities including Flashback/PRI.

Subsequently, in step S35, turbine controller 9 sends command signals to combustion altering devices depending on the urgency and to rapidly return to the combustion stability requirements. As noted previously, the combustion altering devices include valves 4, 5, and 6, sensors 7, and injection devices 8 described above. In step S36, the combustion altering devices modify the combustion characteristics, and the flow chart then returns to step S31.

This written description uses example implementations of methods and systems to disclose the inventions, including the best mode, and also to enable any person skilled in the art to practice the inventions, including making and using any devices or systems and performing any incorporated methods. The patentable scope of the inventions is defined by the claims, and may include other examples that occur to those skilled in the art. Such other examples are intended to be within the scope of the claims if they have structural elements or process steps that do not differ from the literal language of the claims, or if they include equivalent structural elements or process steps with insubstantial differences from the literal language of the claims.

What is claimed:

1. A method of operating a gas turbine system, having discrete fuel and air delivery systems connected to a combustor, and a controller for controlling the operation of the gas turbine system to prevent or reduce the risk of combustion instabilities, said method comprising:
using at least one processor in the controller to perform the following steps,
storing stable transient time rate of change of combustion characteristics in a memory of the controller;
measuring actual operating transient time rate of change of combustion characteristics during operation of the gas turbine system which correspond to said stored stable transient time rate of change of combustion characteristics;
comparing the actual operating transient time rate of change of combustion characteristics to said stored stable transient time rate of change of combustion characteristics;
determining if at least one of said actual operating transient time rate of change of combustion characteristics exceeds a corresponding one of said stored stable transient time rate of change of combustion characteristics;
adjusting at least one gas turbine operating parameter to control the at least one of said actual operating transient time rate of change of combustion characteristics determined to exceed the corresponding one of said stored stable transient time rate of change of combustion characteristics.

2. The method of claim 1 wherein said gas turbine operating parameters include: Fuel-to-Air Ratio (FAR); Fuel and air distribution within the combustor (e.g., change fuel Primary, Secondary, Pilot, Late Lean Injection by modifying fuel splits; change air flow splits between combustion zones); absolute value and rate of fuel and air supply change; rate of fuel composition; adding inert gases and/or water/steam to the combustor; the flow rate and/or make up of emissions gases including one or more of COₓ, NOₓ, and Hydrocarbons.

3. The method of claim 2 wherein the controller reduces the time rate of change of said actual combustion oscillations to prevent or reduce the risk of combustion instabilities.

4. The method of claim 1 wherein the controller chooses the operating parameter which provides the fastest way to prevent or reduce the risk of combustion instabilities.

5. The method of claim 2, wherein said controller controls valves of said fuel delivery system for mixing relative amounts of high and low LHV fuels fed to the combustor to prevent or reduce the risk of combustion instabilities.

6. The method of claim 2, wherein said controller controls valves of a steam delivery system for introducing steam to the combustor to prevent or reduce the risk of combustion instabilities.

7. The method of claim 2, wherein said controller controls valves of a water delivery system for introducing water to the combustor to prevent or reduce the risk of combustion instabilities.

8. The method of claim 2, wherein said controller controls fuel split within the combustor to prevent or reduce the risk of combustion instabilities.

9. The method of claim 2, wherein said controller controls fuel-to-air ratio within the combustor to prevent or reduce the risk of combustion instabilities.

10. The method of claim 2, wherein said controller controls air flow splits between combustion zones within the combustor to prevent or reduce the risk of combustion instabilities.

11. The method of claim 2, wherein said controller controls flow rate and/or make up of emission gases including at least one of CO_{X}, NOₓ, and unburned Hydrocarbons to prevent or reduce the risk of combustion instabilities.

12. The method of claim 2, wherein said controller controls valves for introducing inert gases within the combustor to prevent or reduce the risk of combustion instabilities.

13. The method of claim 2, wherein said controller controls rate of fuel consumption within the combustor to prevent or reduce the risk of combustion instabilities.

14. A gas turbine system, having discrete fuel and air delivery systems connected to a combustor, and a controller for controlling the system to prevent or reduce the risk of combustion instabilities, said system comprising:
a memory associated with said controller for storing stable transient time rate of change of combustion characteristics; and
sensors for measuring actual operating transient time rate of change of combustion characteristics during operation of the gas turbine system which correspond to said stored stable transient time rate of change of combustion characteristics;
wherein the controller compares said actual operating transient time rate of change of combustion characteristics to said stored stable transient time rate of change of combustion characteristics and determines if at least one of said actual operating transient time rate of change of combustion characteristics exceeds a corresponding one of said stored stable transient time rate of change of combustion characteristics;
wherein the controller controls at least one gas turbine operating parameter to control the at least one of said actual operating transient time rate of change of combustion characteristics determined to exceed the corresponding one of said stored stable transient time rate of change of combustion characteristics.

15. The system of claim 14 wherein said gas turbine operating parameters include: Fuel-to-Air Ratio (FAR); Fuel and air distribution within the combustor (e.g., change fuel Primary, Secondary, Pilot, Late Lean Injection by modifying fuel splits; change air flow splits between combustion zones); absolute value and rate of fuel and air supply change; rate of fuel composition; adding inert gases and/or water/steam to the combustor; the flow rate and/or make up of emissions gases including one or more of CO_{X}, NOₓ, and unburned Hydrocarbons.

16. A system as claimed in claim 15, wherein said controller controls valves of said fuel delivery system for mixing relative amounts of high and low LHV fuels fed to the combustor to prevent or reduce the risk of combustion instabilities.

17. A system as claimed in claim 15, wherein said controller controls valves of a steam delivery system for introducing steam to the combustor to prevent or reduce the risk of combustion instabilities.

18. A system as claimed in claim 15, wherein said controller controls valves of a water delivery system for introducing water to the combustor to prevent or reduce the risk of combustion instabilities.

19. A system as claimed in claim 15, wherein said controller controls fuel split within the combustor to prevent or reduce the risk of combustion instabilities.

20. A system as claimed in claim 15, wherein said controller controls fuel-to-air ratio within the combustor to prevent or reduce the risk of combustion instabilities.

21. A system as claimed in claim 15, wherein said controller controls air flow splits between combustion zones within the combustor to prevent or reduce the risk of combustion instabilities.

22. A system as claimed in claim 15, wherein said controller controls flow rate and/or make up of emission gases including at least one of COₓ, NOₓ, and Hydrocarbons to prevent or reduce the risk of combustion instabilities.

23. A system as claimed in claim 15, wherein said controller controls valves for introducing inert gases within the combustor to prevent or reduce the risk of combustion instabilities.

24. A system as claimed in claim 15, wherein said controller controls rate of fuel consumption within the combustor to prevent or reduce the risk of combustion instabilities.
